(19) United States
(12) Patent Application Publication
(10) Pub. No.: US 2017/0271746 A1
(43) Pub. Date: Sep. 21, 2017

(54) ANTENNA DEVICE AND PORTABLE WIRELESS DEVICE USING THE SAME

(71) Applicant: TDK Corporation, Tokyo (JP)

(72) Inventors: Toshifumi KOMACHI, Tokyo (JP); Toshio TOMONARI, Tokyo (JP); Hirohumi ASOU, Tokyo (JP)

(73) Assignee: TDK Corporation, Tokyo (JP)

(21) Appl. No.: 15/459,326

(22) Filed: Mar. 15, 2017

(30) Foreign Application Priority Data
Mar. 18, 2016 (JP) 2016-056010

(51) Int. Cl. H01Q 1/24; H01Q 7/00; H04B 5/00; H01Q 1/38

(52) U.S. Cl. CPC H01Q 1/242; H01Q 1/38; H01Q 7/00; H04B 5/0081

(57) ABSTRACT

Disclosed herein is an antenna device that includes a planar coil pattern formed on a substrate and a composite magnetic sheet positioned on an opposite side to the substrate with respect to the planar coil pattern. The composite magnetic sheet comprises soft magnetic metal powder and binder resin. The composite magnetic sheet is supported with a predetermined distance from the planar coil pattern.

### BACKGROUND OF THE INVENTION

Field of the Invention

The present invention relates to an antenna device and a portable wireless device provided with the antenna device and, more particularly, to an antenna device suitable for NFC (Near Field Communication) and a portable wireless device provided with the antenna device.

Description of Related Art

In recent years, an RFID (Radio Frequency Identification) system is implemented in a portable wireless device such as a smartphone, and such a portable wireless device is provided with an antenna device for performing near field communication with a reader/writer as a communication means. As an antenna device of such a type, an antenna device described in Japanese Patent Application Laid-open No. 2006-13976 is known.

The antenna device described in Japanese Patent Application Laid-open No. 2006-13976 has a configuration in which an antenna substrate is provided on a composite magnetic sheet obtained by mixing soft magnetic metal powder with binder resin. With this configuration, the composite magnetic sheet is interposed between the antenna substrate and a circuit board having a plurality of conductors, so that degradation in antenna characteristics due to influence of the circuit board can be suppressed.

However, in the antenna device described in Japanese Patent Application Laid-open No. 2006-13976, the antenna substrate and composite magnetic sheet contact each other, so that a planar coil pattern formed on the antenna substrate and soft magnetic metal powder contained in the composite magnetic sheet may contact each other.

In order to solve such a problem, it is necessary to separate the antenna substrate and composite magnetic sheet from each other; in this case, however, the problem is how the antenna substrate is supported. That is, when the antenna substrate and composite magnetic sheet are separated from each other, it is necessary to support the antenna substrate from the upper side (i.e., side opposite to the composite magnetic sheet) thereof. In this case, when the planar coil pattern is formed on the upper surface side of the antenna substrate, a support member for the antenna substrate may contact the planar coil pattern. Further, even when the planar coil pattern does not contact the support member, antenna characteristics may vary due to proximity between them.

### SUMMARY

It is therefore an object of the present invention to provide an antenna device capable of preventing contact between the planar coil pattern and soft magnetic metal power or support member and preventing degradation in antenna characteristics due to proximity between them and a portable wireless device provided with the antenna device.

An antenna device according to the present invention includes a planar coil pattern formed on a substrate and a composite magnetic sheet positioned on the opposite side to the substrate with respect to the planar coil pattern and obtained by mixing soft magnetic metal powder with binder resin. The composite magnetic sheet is supported with a predetermined distance from the planar coil pattern.

A portable wireless device according to the present invention is provided with the antenna device.

According to the present invention, the composite magnetic sheet is provided spaced apart from the planar coil pattern, so that contact between the planar coil pattern and soft magnetic metal powder is reliably prevented. In addition, the planar coil pattern is positioned between the composite magnetic sheet and substrate, so that even in a configuration where the substrate is supported by a support member on the upper surface side of the substrate, contact between the support member and planar coil pattern can be prevented. Thus, when the antenna device according to the present invention is used for near field wireless communication where data is transmitted/received at a frequency of, e.g., 13.56 MHz, it is possible to obtain satisfactory communication characteristics with a reader/writer or the like.

The antenna device according to the present invention preferably further includes a spacer layer provided between the planar coil pattern and composite magnetic sheet so as to keep the distance between the planar coil pattern and composite magnetic sheet at the predetermine distance. Thus, the distance between the planar coil pattern and composite magnetic sheet can be reliably kept.

In the present invention, the predetermined distance is preferably set to 20 μm or more. With this configuration, floating capacitance between the planar coil pattern and soft magnetic metal powder is reduced, so that an increase in inductance due to the floating capacitance is suppressed, thereby allowing communication distance to be extended.

In the present invention, the surface of the soft magnetic metal powder is preferably insulation-coated. With this configuration, the volume resistance of the composite magnetic sheet is increased, whereby inductance of the antenna device can be increased further. In this case, the predetermined distance is preferably set to 10 μm or more. With this configuration, floating capacitance between the planar coil pattern and soft magnetic metal powder is reduced, so that communication distance can be extended. Further, the soft magnetic metal powder preferably has a flat shape. With this configuration, more satisfactory magnetic characteristics can be obtained.

In the present invention, a metal pattern may be disposed on the opposite side to the planar coil pattern with respect to the composite magnetic sheet. Even in this case, degradation in antenna characteristics due to the metal pattern is suppressed since the composite magnetic sheet is interposed between the planar coil pattern and metal pattern. The metal pattern may be a part of a battery pack incorporated in the portable wireless device.

In this case, the predetermine distance is preferably set to equal to or less than the distance between the composite magnetic sheet and metal pattern. As a result, effect of the composite magnetic sheet as a magnetic path can be sufficiently exhibited.

As described above, according to the present invention, contact between the planar coil pattern and soft magnetic metal powder or support member can be prevented, and satisfactory antenna characteristics can be ensured.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a plan view illustrating a configuration of an antenna device according to a preferred embodiment of the present invention;

FIG. 2 is a cross-sectional view taken along the A-A line of FIG. 1;

FIG. 3 is an explanatory schematic diagram of the shape of a magnetic powder having a flat shape;

FIG. 4 is a cross-sectional view of the soft magnetic metal powder coated with an insulating film;

FIG. 5 is a cross-sectional view for explaining a first method of supporting the composite magnetic sheet;

FIG. 6 is a cross-sectional view for explaining a second method of supporting the composite magnetic sheet;

FIG. 7 is a cross-sectional view for explaining a third method of supporting the composite magnetic sheet;

FIG. 8 is a graph showing a result of an EXAMPLE 1;

FIG. 9 is a graph showing a result of an EXAMPLE 2; and

FIG. 10 is a graph showing a result of an EXAMPLE 3;

### DETAILED DESCRIPTION OF THE EMBODIMENTS

Preferred embodiments of the present invention will be explained below in detail with reference to the accompanying drawings.

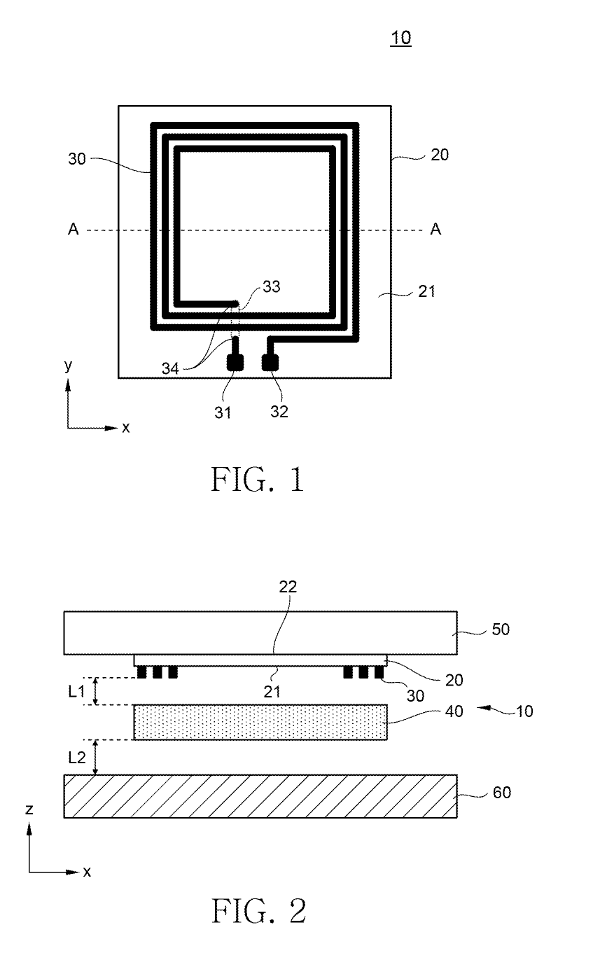

FIG. 1 is a plan view illustrating a configuration of an antenna device 10 according to a preferred embodiment of the present invention. FIG. 2 is a cross-sectional view taken along the A-A line of FIG. 1.

As illustrated in FIGS. 1 and 2, the antenna device 10 according to the present embodiment includes a substrate 20, a planar coil pattern 30 formed on a front surface 21 of the substrate 20, and a composite magnetic sheet 40 provided spaced apart from the planar coil pattern 30.

The substrate 20 is a flexible substrate made of PET resin and has a planar size of e.g., about 40×50 mm and a thickness of about 30 μm, but not particularly limited thereto. The substrate 20 has front and back surfaces 21 and 22 constituting an xy plane, and the planar coil pattern 30 is mainly formed on the front surface 21 side of the substrate 20. The back surface 22 of the substrate 20 is fixed to a predetermined support member 50. The support member 50 is, for example, a casing of a portable wireless device incorporating the antenna device 10 according to the present embodiment. In this case, the substrate 20 is bonded to the inner surface of the casing of the portable wireless device.

The planar coil pattern 30 is a spiral conductor formed on the substrate 20. In the example illustrated in FIG. 1, the outer shape of the planar coil pattern 30 is a rectangle, and the number of turns thereof is three; however, the present invention is not limited thereto. The planar coil pattern 30 may be formed by plating, or may be formed by etching or patterning a metal layer previously formed on the entire front surface 21 of the substrate 20.

As illustrated in FIG. 1, the inner peripheral end of the planar coil pattern 30 is connected to a terminal 31, and outer peripheral end of the planar coil pattern 30 is connected to a terminal 32. Particularly, the inner peripheral end of the planar coil pattern 30 is connected to the terminal 31 through a bridge part 33 crossing the spiral conductor. In the example illustrated in FIG. 1, the bridge part 33 is formed on the back surface 22 of the substrate 20, and the both ends of the bridge part 33 are connected to a conductor pattern formed on the front surface 21 of the substrate 20 through a through hole conductor 34 formed so as to penetrate the substrate 20. However, the bridge part 33 need not necessarily be formed on the back surface 22 of the substrate but may be formed on an insulating layer covering the planar coil pattern 30.

The terminals 31 and 32 of the planar coil pattern 30 are connected to a not illustrated RF circuit incorporated in the portable wireless device. With this configuration, the antenna device 10 according to the present embodiment can be used for near field wireless communication where data is transmitted/received at a frequency of, e.g., 13.56 MHz.

The composite magnetic sheet 40 is positioned on the opposite side to the substrate 20 with respect to the planar coil pattern 30 and is spaced apart from the planar coil pattern 30 by a predetermined distance L1 in the z-direction.

A metal pattern 60 is disposed on the opposite side to the planar coil pattern 30 with respect to the composite magnetic sheet 40. The metal pattern 60 is, for example, a battery pack of the portable wireless device. When the metal pattern 60 having a large area exists in the vicinity of the antenna device 10, inductance is significantly reduced due to eddy current loss. However, interposing the composite magnetic sheet 40 between the planar coil pattern 30 and metal pattern 60 allows the composite magnetic sheet 40 to function as a magnetic path, so that high inductance can be ensured, which can improve antenna characteristics.

The composite magnetic sheet 40 is obtained by mixing soft magnetic metal powder with binder resin. Examples of the soft magnetic metal powder include magnetic stainless (Fe—Cr—Al—Si based alloy), sendust (Fe—Si—Al based alloy), permalloy (Fe—Ni based alloy), Fe—Si based alloy, Fe—Si—B (—Cu—Nb) based alloy, Fe—Ni—Cr—Si based alloy, Fe—Si—Cr based alloy, Fe—Si—Al—Ni—Cr based alloy, Mo—Ni—Fe based alloy, and amorphous alloy. Particularly, use of Fe—Si based alloy or Fe—Si—Cr based alloy allows more satisfactory magnetic characteristics to be obtained.

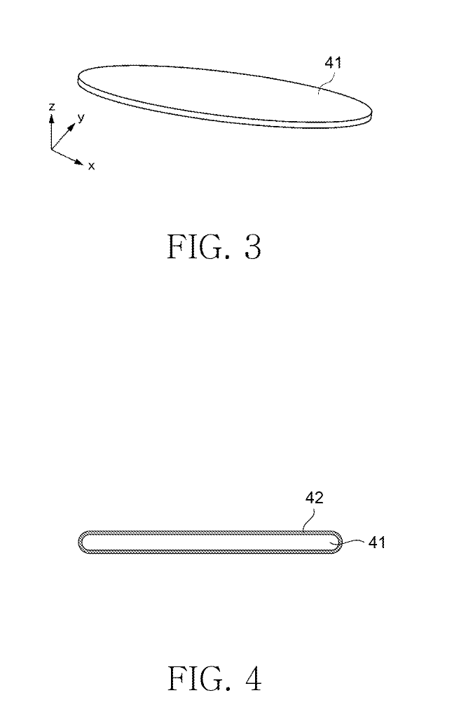

The soft magnetic metal powder is not particularly limited in shape but has preferably a flat shape and has preferably an aspect ratio of five or more. FIG. 3 is a schematic view illustrating the outer shape of a soft magnetic metal powder 41 having a flat shape. As illustrated in FIG. 3, the flat soft magnetic metal powder 41 is preferably flattened in the xy direction. In this case, high permeability can be obtained in the xy direction which is the main direction of a magnetic flux passing the composite magnetic sheet 40. The median diameter of the flat soft magnetic metal powder 41 is preferably about 25 μm to 50 μm.

Examples of the binder resin contained in the composite magnetic sheet 40 include polyester resin, polyurethane resin, epoxy resin, polyamide resin, acrylic resin, nitrile-butadiene rubber, and ethylene-propylene rubber. Considering processability, polyurethane resin is most preferably used.

As illustrated in FIG. 4 which is a cross-sectional view of the soft magnetic metal powder 41 of FIG. 3, the surface of the soft magnetic metal powder 41 is preferably insulation-coated with an insulating film 42. When the surface of the soft magnetic metal powder 41 is insulation-coated, the volume resistance of the composite magnetic sheet 40 is enhanced, so that inductance can be increased. The insulation coating can be formed by applying chemical treatment to the soft magnetic metal powder 41 using phosphoric acid or phosphate.

As described above, in the present embodiment, the soft magnetic metal powder 41 is contained in the composite magnetic sheet 40, whereby high permeability can be obtained. On the other hand, however, the soft magnetic metal powder 41 is a conductor, so that when it is brought into contact with the planar coil pattern 30, a short circuit failure may occur. Further, when the planar coil pattern 30 and composite magnetic sheet 40 are in proximity to each other even though they do not contact each other, impedance is increased by floating capacitance between the planar coil pattern 30 and composite magnetic sheet 40, with the result that communication distance is reduced.

With attention focused on this point, in the present embodiment, the planar coil pattern 30 and composite magnetic sheet 40 are supported spaced apart from each other so as to reduce the floating capacitance generated between them. A distance between the planar coil pattern 30 and composite magnetic sheet 40 is preferably 10 μm or more when the surface of the soft magnetic metal powder 41 is insulation-coated and preferably 20 μm or more when the surface of the soft magnetic metal powder 41 is not insulation-coated. That is, when the surface of the soft magnetic metal powder 41 is insulation-coated, influence of the floating capacitance is substantially eliminated by setting the distance L1 to 10 μm or more; when the surface of the soft magnetic metal powder is not insulation-coated, influence of the floating capacitance is substantially eliminated by setting the distance L1 to 20 μm or more. In either case, even when the distance L1 is made larger than the above value, the floating capacitance is not reduced. Considering this point, when the surface of the soft magnetic metal powder 41 is insulation-coated, the distance L1 is preferably set to 10 μm or more and 40 μm or less and more preferably to 10 μm or more and 25 μm or less for height reduction. Further, when the surface of the soft magnetic metal powder 41 is not insulation-coated, the distance L1 is preferably set to 20 μm or more and 50 μm or less and more preferably to 20 μm or more and 35 μm or less for height reduction.

The upper limit of the distance L1 is not particularly limited. However, when the distance L1 is large, the distance between the planar coil pattern 30 and composite magnetic sheet 40 also becomes large, with the result that influence that the metal pattern has on antenna characteristics is reduced; on the other hand, when the distance L1 is excessively large, the role of the composite magnetic sheet 40 as a magnetic path is lowered. Considering the above points, although the upper limit of the distance L1 is not particularly limited, it is preferably set to equal to or less than a distance L2 between the composite magnetic sheet 40 and metal pattern 60.

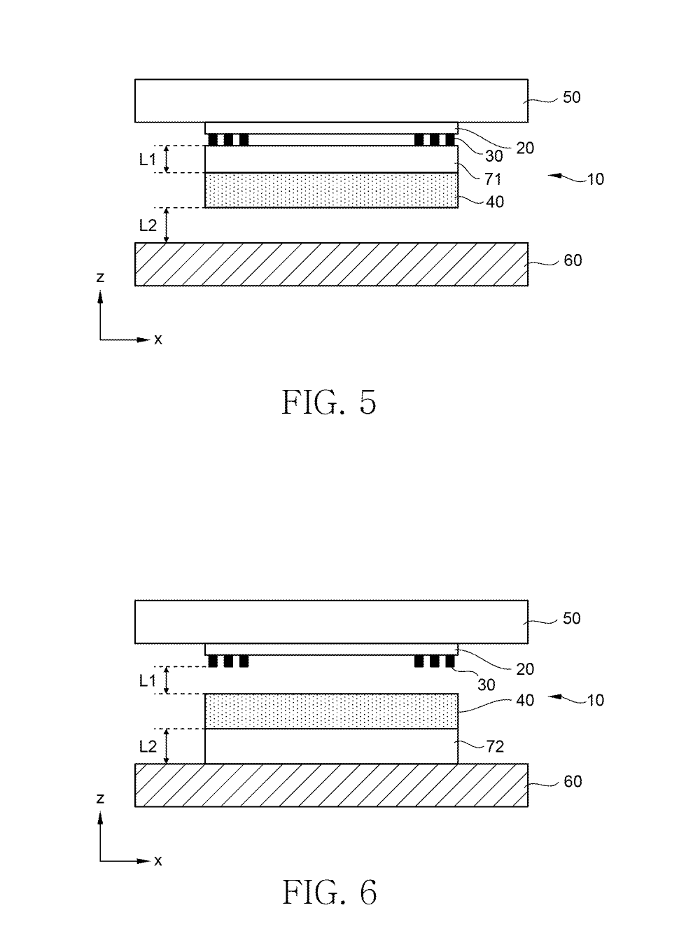

FIG. 5 is a cross-sectional view for explaining the first method of supporting the composite magnetic sheet 40.

In the example of FIG. 5, a spacer layer 71 is provided between the planar coil pattern 30 and composite magnetic sheet 40, whereby the distance L1 between the planar coil pattern 30 and composite magnetic sheet 40 is kept. In this case, the distance L1 between the planar coil pattern 30 and composite magnetic sheet 40 can be reliably adjusted by adjusting the thickness of the spacer layer 71. Thus, by setting the thickness of the spacer layer 71 to 10 μm or more when the surface of the soft magnetic metal powder 41 is insulation-coated and by setting the thickness of the spacer layer 71 to 20 μm or more when the surface of the soft magnetic metal powder 41 is not insulation-coated, it is possible to obtain satisfactory antenna characteristics. Any material may be used for the spacer layer 71 as long as it is a material having an insulating property. For example, an insulating resin member may be used as the spacer layer 71 and bonded to the planar coil pattern 30 and composite magnetic sheet 40 by an adhesive. Alternatively, an adhesive itself may be used as the spacer layer 71.

FIG. 6 is a cross-sectional view for explaining the second method of supporting the composite magnetic sheet 40.

In the example of FIG. 6, the composite magnetic sheet 40 is fixed to the metal pattern 60 through an adhesive 72. In this case, when the positional relationship between the support member 50 and metal pattern 60 is fixed, it is possible to adjust the distance L1 between the planar coil pattern 30 and composite magnetic sheet 40 by adjusting the thickness of the adhesive 72. In this example, the surface of the planar coil pattern 30 is not covered by a member such as the spacer layer 71, so that it is possible to prevent magnetic characteristics from varying due to existence of a member in the vicinity of the planar coil pattern 30.

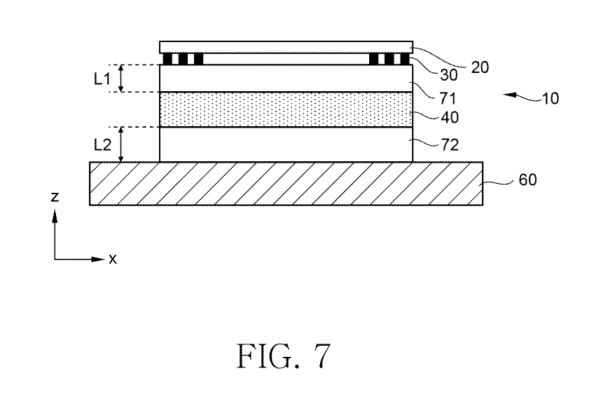

FIG. 7 is a cross-sectional view for explaining the third method of supporting the composite magnetic sheet 40.

In the example of FIG. 7, the composite magnetic sheet 40 is fixed to the metal pattern 60 by the adhesive 72, and the spacer layer 71 is provided between the planar coil pattern 30 and composite magnetic sheet 40. In this example, both the planar coil pattern 30 and composite magnetic sheet 40 are fixed to the metal pattern 60, thus eliminating the need to provide the support member 50 for supporting the substrate 20.

The configurations of the antenna device 10 have thus been described. As described above, in the antenna device 10 according to the present embodiment, the soft magnetic metal powder 41 is contained in the composite magnetic sheet 40, so that high permeability can be obtained, whereby antenna characteristics are improved. In addition, the composite magnetic sheet 40 and planar coil pattern 30 are spaced apart from each other, so that the planar coil pattern 30 and soft magnetic metal powder 41 are prevented from contacting each other, and increase in impedance due to floating capacitance is suppressed. Furthermore, the planar coil pattern 30 is sandwiched between the substrate 20 and composite magnetic sheet 40, so that a variation in antenna characteristics due to contact or proximity between the planar coil pattern 30 and other member does not occur.

Thus, when the antenna device 10 according to the present embodiment is used for near field wireless communication where data is transmitted/received at a frequency of, e.g., 13.56 MHz, it is possible to ensure longer communication distance than conventionally.

It is apparent that the present invention is not limited to the above embodiments, but may be modified and changed without departing from the scope and spirit of the invention.

### EXAMPLES

### Example 1

The antenna device 10 having the configuration illustrated in FIG. 5 was produced, and how the communication distance thereof was changed by variously changing the thickness of the spacer layer 71 was measured. The planar size of the planar coil pattern 30 was 40×30 mm, the conductor thickness thereof was 35 μm, and the number of turns thereof was four. The composite magnetic sheet 40 was obtained by mixing Fe—Si—Cr alloy powder as the soft magnetic metal powder with polyurethane resin. However, in Example 1, insulation coating was not applied to the surface of the Fe—Si—Cr alloy powder. The material for the spacer 71 layer was PET resin. The distance L2 between the composite magnetic sheet 40 and metal pattern 60 was set to 10 μm irrespective of the thickness L1 of the spacer layer 71.

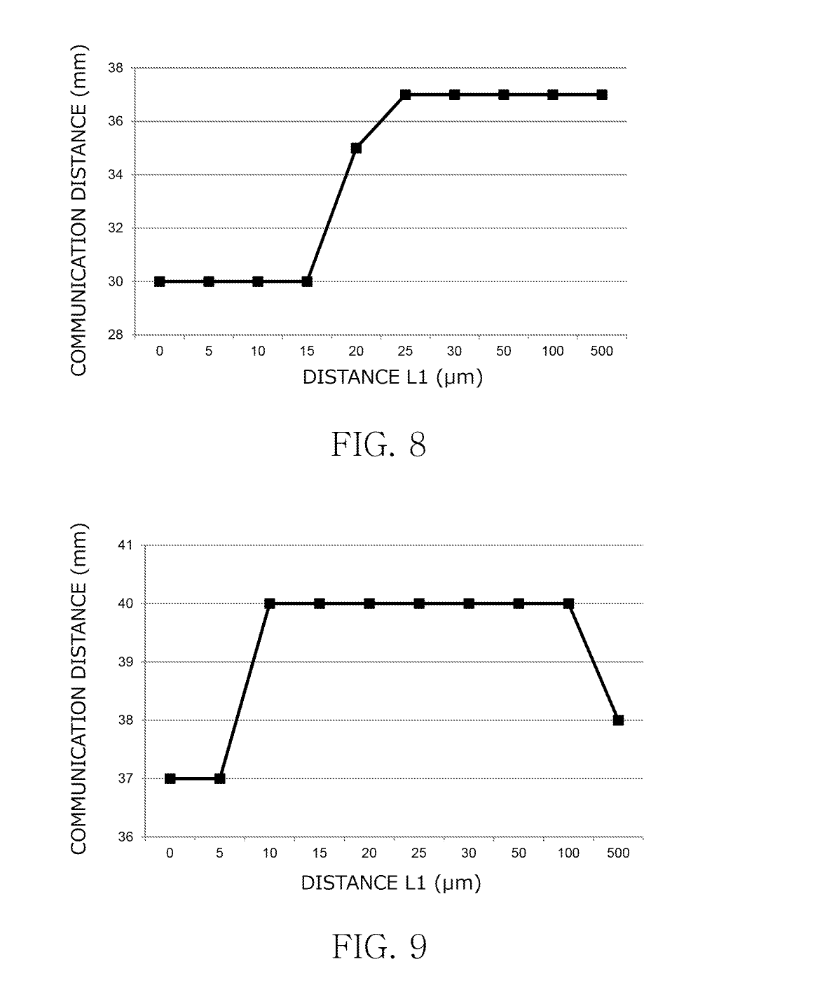

Under the conditions as described above, communication was performed at a frequency of 13.56 MHz while gradually changing the distance from a reader/writer, and the maximum distance at which communication can normally performed, i.e., the communication distance was measured. The result is illustrated in FIG. 8.

As illustrated in FIG. 8, in a region where the thickness of the spacer layer 71, i.e., the distance L1 between the planar coil pattern 30 and composite magnetic sheet 40 is equal to or less than 15 μm, the communication distance is 30 mm, while when the distance L1 is equal to or more than 20 μm, the communication distance is notably increased to 35 mm or more. This effect is saturated when the distance L1 is equal to or more than 25 μm, and the communication distance is not changed even when the distance L1 is increased further.

### Example 2

The communication distance was measured under the same conditions as those in Example 1 except that insulation coating was applied to the surface of the Fe—Si—Cr alloy powder. The result is illustrated in FIG. 9.

As illustrated in FIG. 9, in a region where the thickness of the spacer layer 71, i.e., the distance L1 between the planar coil pattern 30 and composite magnetic sheet 40 is equal to or less than 5 μm, the communication distance is 37 mm, while when the distance L1 is equal to or more than 10 μm, the communication distance is notably increased to 40 mm. However, when the distance L1 is increased up to 500 μm, the communication distance is reduced to 38 mm. That is, the planar coil pattern 30 and composite magnetic sheet 40 are too far away from each other, so that the inductance of the planar coil pattern 30 is reduced.

### Example 3

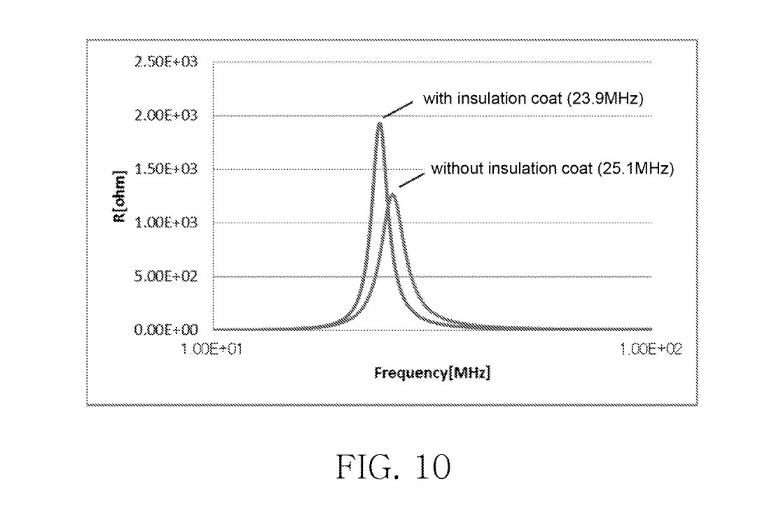

The volume resistances of a composite magnetic sheet having Fe—Si—Cr alloy powder whose surface was not insulation-coated and a composite magnetic sheet having Fe—Si—Cr alloy powder whose surface was insulation-coated were measured. The insulation coating for the Fe—Si—Cr alloy powder was performed by phosphoric acid treatment. Polyurethane resin was used as the binder resin, and the thickness thereof was 100 μm. The result is illustrated in FIG. 10.

As illustrated in FIG. 10, a higher volume resistance is obtained in the composite magnetic sheet having Fe—Si—Cr alloy powder whose surface is insulation-coated (subjected to phosphoric acid treatment) than in the composite magnetic sheet having Fe—Si—Cr alloy powder whose surface is not insulation-coated (not subjected to phosphoric acid treatment), and the frequency at which a peak is measured is lower.

What is claimed is:

1. An antenna device comprising:
a planar coil pattern formed on a substrate; and
a composite magnetic sheet positioned on an opposite side to the substrate with respect to the planar coil pattern,
wherein the composite magnetic sheet comprises soft magnetic metal powder and binder resin, and
wherein the composite magnetic sheet is supported with a predetermined distance from the planar coil pattern.

2. The antenna device as claimed in claim 1, further comprising a spacer layer provided between the planar coil pattern and the composite magnetic sheet so as to keep a distance between the planar coil pattern and composite magnetic sheet at the predetermine distance.

3. The antenna device as claimed in claim 1, wherein the predetermined distance is 20 μm or more.

4. The antenna device as claimed in claim 1, wherein the soft magnetic metal powder is insulation-coated.

5. The antenna device as claimed in claim 4, wherein the predetermined distance is 10 μm or more.

6. The antenna device as claimed in claim 4, wherein the soft magnetic metal powder has a flat shape.

7. The antenna device as claimed in claim 1, wherein a metal pattern is disposed on an opposite side to the planar coil pattern with respect to the composite magnetic sheet.

8. The antenna device as claimed in claim 7, wherein the metal pattern is a part of a battery pack.

9. The antenna device as claimed in claim 7, wherein the predetermine distance is equal to or less than a distance between the composite magnetic sheet and metal pattern.

10. The antenna device as claimed in claim 1, wherein the antenna device is used for near field wireless communication where data is transmitted/received at a frequency of 13.56 MHz.

11. A portable wireless device having an antenna device, wherein the antenna device comprising:
a planar coil pattern formed on a substrate; and
a composite magnetic sheet positioned on an opposite side to the substrate with respect to the planar coil pattern,
wherein the composite magnetic sheet comprises soft magnetic metal powder and binder resin, and
wherein the composite magnetic sheet is supported with a predetermined distance from the planar coil pattern.

12. An antenna device comprising:
a substrate having front and back surfaces opposite to each other, the back surface of the substrate being fixed to a support member;
a coil pattern formed on the front surface of the substrate; and
a magnetic sheet covering the coil pattern with a predetermined distance from the coil pattern so as not to contact the coil pattern.

13. The antenna device as claimed in claim 12, further comprising a spacer provided between the coil pattern and the magnetic sheet.

14. The antenna device as claimed in claim 12, wherein the magnetic sheet is fixed to another support member.

15. The antenna device as claimed in claim 14, wherein the coil pattern faces the magnetic sheet with an intervention of a free space.

16. The antenna device as claimed in claim 14, wherein the predetermine distance is less than a distance between the magnetic sheet and the another support member.
